(19) United States
(12) Patent Application Publication
(10) Pub. No.: US 2024/0114859 A1
(43) Pub. Date: Apr. 11, 2024

(54) CONTROLLABLE IRRIGATION SYSTEM, METHOD, AND DEVICE

(71) Applicant: KRADO, INC., Salt Lake City, UT (US)

(72) Inventors: Jesse Linton MONTGOMERY, Centerville, UT (US); Eric Andrew LO, Salt Lake City, UT (US); Maxwell Wagner ONO, Portland, OR (US)

(73) Assignee: KRADO, INC., Salt Lake City, UT (US)

(21) Appl. No.: 18/543,960

(22) Filed: Dec. 18, 2023

Related U.S. Application Data
(62) Division of application No. 16/874,377, filed on May 14, 2020, now abandoned.
(60) Provisional application No. 62/899,273, filed on Sep. 12, 2019.
(60) Provisional application No. 62/848,334, filed on May 15, 2019.

(51) Int. Cl. A01G 25/16; A01G 25/02; H02S 40/38; H04W 4/029

(52) U.S. Cl. CPC A01G 25/165; A01G 25/02; A01G 25/167; H02S 40/38; H04W 4/029

(57) ABSTRACT

Methods, systems, and devices for a controllable irrigation and environment monitoring system, devices, and applications, are described. The irrigation system may use a valve on each spray head which may allow each spray head of the irrigation system to be independently controlled. The spray radius and the water flow of each of the spray heads may be individually adjusted. The irrigation system may include sensors which provide feedback and the system may individually adjust each of the spray heads of the irrigation system and may adjust the watering schedule, water flow, and spray radius based on the sensor feedback. The irrigation system may be automated and self-managed and may adjust watering schedules according to an algorithm. The algorithm may use data collected by the system and also may use user-defined parameters such as local watering restrictions.

### CROSS REFERENCE TO RELATED APPLICATION

This application is a divisional of U.S. patent application Ser. No. 16/874,377, filed 14 May 2020, and entitled CONTROLLABLE IRRIGATION SYSTEM, METHOD, AND DEVICE, which claims the benefit of U.S. Provisional Patent Application No. 62/848,334, filed 15 May 2019, and entitled CONTROLLABLE IRRIGATION SYSTEM, METHOD, AND DEVICE, and U.S. Provisional Patent Application No. 62/899,273, filed 12 Sep. 2019, and entitled SELF-CHARGING WIRELESS IRRIGATION VALVE, the disclosures of which are incorporated, in their entireties, by this reference.

### BACKGROUND

Currently, irrigation systems may irrigate sections of landscaping, lawns, soil, and so forth, by operating valves that control watering zones. The watering zones may be a group of multiple spray heads or sprinklers that are controlled in groups or simultaneously. The sprinklers in the watering zones may be manually set at a watering radius and spray distance, both of which are static during watering routines. Although the watering systems may be manually set, differences in shade, soil type, landscaping features, system design, and other factors often prevent optimal watering to all areas. To prevent underwatering, watering times are increased to compensate for the areas of lowest efficiency. This results in overwatering of other areas, leading to wasting water and potential landscape damage.

The flow of water in irrigation systems is typically controlled with valves. Each valve controls flow to a cluster or zone of one or more sprinklers. Several mechanisms exist for opening and closing irrigation valves. Usually valves are hardwired and receive an electrical signal from a central controller device. However, there are situations where running wires to the valves is not desired or practical. For example, the distance between the central controller and the valve could be great or there may be physical barriers separating the two. It may also be desirable to have a configurable system where valves could be added without running additional wires.

### SUMMARY

Methods, systems, and devices that support automated irrigation systems are described. Generally, the described techniques provide for a controllable valve on each of the spray heads of the irrigation system, which may allow for controlling the spray heads independently of one another. The spray heads may be capable of automatic or manual adjustment of the spray radius as appropriate. The spray heads may distribute water to the appropriate areas without overwatering areas that have been sufficiently irrigated. In some examples, the irrigation system may include separate devices which may include sensors, and which may provide feedback for the individual regions and the appropriate water schedule, water distribution, and relevant environmental factors, and so forth. The sensors and the spray heads may communicate with one another and with other appropriate devices via wired communications or wirelessly.

In some examples, the automated irrigation systems may be automated and self-managed. The watering schedules may be adjusted according to an algorithm. The algorithm may be capable of adjusting the watering schedule and water distribution (e.g., spray radius) based on data collected by the system and other user-defined parameters (e.g., local watering restrictions). Additionally, the system may be adjusted via software or an application which may provide for manual adjustment and control.

An apparatus for an irrigation system is described. The apparatus may be a watering device which may include a spray head. The spray head may be configured to distribute water over a spray radius. The watering device may include a control valve which may be operably coupled to the spray head and configured to control water flow to the spray head independently from other spray heads of the irrigation system. Also included may be a motor which may be operably coupled to the spray head and configured to control approximately 360 degrees of rotation of the spray head. The rotation control of the spray head may be independent from other spray heads of the irrigation system. The watering device may include a wireless communications device which may be operably coupled to the control valve and may be configured to receive soil moisture feedback. The wireless communication device may additionally be configured to adjust at least one of the water flow to the spray head and/or the rotation of the spray head based on the soil moisture feedback.

A watering system for irrigation is described. The watering system may include multiple spray heads which may be configured to distribute water to soil over a spray radius, and may also include multiple environment feedback sensors which may be configured to sense a water content of the soil included in the spray radius. Additionally, the watering system may include a controller which may be configured to receive the water content of the soil from at least one environment feedback sensor of the multiple environment feedback sensors. The controller may be further configured to communicate with at least the spray head of the multiple spray heads to adjust the water distribution of the spray head, where the adjustment of the water distribution of the spray head is independent of the adjustments of the water distribution of the other spray heads of the multiple spray heads of the watering system.

An irrigation system is described. The irrigation system may include multiple spray heads which may be configured to distribute water to soil over a spray radius, and may include multiple environment feedback sensors which may be configured to sense a water content of the soil. Additionally, the irrigation system may include a controller which may be configured to request a water content value of soil from at least an environment feedback sensor of the multiple environment feedback sensors and may be configured to receive the water content value from the environment feedback sensor of the multiple environment feedback sensors. The controller may be further configured to identify that the water content value is below a threshold and may be configured to adjust at least one of a water flow or the spray radius of a spray head of the multiple spray heads, where the adjustment of the spray head of the multiple spray heads may be independent of the other spray heads of the plurality of spray heads of the irrigation system.

An environment monitoring system is described. Environment feedback sensors may operate independently of an irrigation system, providing feedback to a user on soil moisture, humidity, temperature, light, or other environmental factors.

A water control device is described. The water control device including a valve mechanism, a rechargeable battery configured to provide power to operate the valve mechanism, a hydroelectric generator operable to generate power to charge the rechargeable battery, and a wireless communication device configured to wirelessly receive control signals from a remote located controller to open and close the valve mechanism.

The wireless communication device may include WiFi, Bluetooth or LTE adapter technology. The hydroelectric generator may include a turbine that rotates in response to exposure to a flow of fluid, a rotor carrying at least one magnet, the rotor being mounted to and rotating with the turbine, and a wire coil that collects energy from the rotating magnets. The hydroelectric generator may be a 5V hydroelectric generator. The hydroelectric generator may be positioned either upstream from the valve mechanism or downstream from the valve mechanism. The rechargeable battery may be a lithium polymer battery. The rechargeable battery may be a 3.7V, 850 mAh battery. The valve mechanism may be a solenoid operated diaphragm valve. The watering device may also include a housing, wherein the valve assembly, rechargeable battery, hydroelectric generator, and wireless communication device are positioned in the housing. The watering device may include a water dispensing device, and the valve mechanism may be operable to deliver a flow of water to the water dispensing device.

A watering system is also disclosed. A watering system includes a controller and a valve assembly located remote from the controller. The valve assembly includes a housing, a valve mechanism mounted to the housing, a rechargeable battery mounted to the housing and configured to provide power to operate the valve mechanism, a hydroelectric generator mounted to the housing and operable to generate power to charge the rechargeable battery, and a wireless communication device mounted to the housing and configured to receive control signals communicated wirelessly from a remote located controller to open and close the valve mechanism.

The watering system may also include a sprinkler, the housing may be a component of the sprinkler, and the valve mechanism may be operable to control flow of water to the sprinkler. The watering system may include a plurality of sprinklers, and the valve mechanism may be operable to control flow of water to the plurality of sprinklers.

A method of operating a watering device is disclosed. The method includes providing a valve mechanism, a rechargeable battery, a hydroelectric generator, and a wireless communication device. The method also includes exposing the hydroelectric generator to a flow of water to generate power, charging the rechargeable battery with the power from the hydroelectric generator, wirelessly receiving a control signal from a controller located remote from the watering device to open the valve mechanism, and opening the valve mechanism with power received from the rechargeable battery.

The method may include providing a sprinkler, and opening the valve mechanism may deliver a flow of water to the sprinkler. The method may include providing a plurality of sprinklers, and opening the valve mechanism may deliver a flow of water to the plurality of sprinklers. The watering device may be mounted to a housing of a sprinkler, and opening the valve mechanism may deliver a flow of water to the sprinkler. The control signal may be received wirelessly via one of WiFi, Bluetooth, and LTE. Opening the valve mechanism may include operating a solenoid and diaphragm. The method may include closing the valve mechanism with power received from the rechargeable battery.

### BRIEF DESCRIPTION OF THE DRAWINGS

Aspects of the disclosure are described in reference to the following figures:

FIG. 1 illustrates an example of an irrigation system layout that supports a controllable irrigation system in accordance with various aspects of the present disclosure;

FIG. 2 illustrates an example of a spray head in a system that supports a controllable irrigation system in accordance with various aspects of the present disclosure;

FIG. 3 illustrates an example of an environment feedback sensor in a system that supports a controllable irrigation system in accordance with various aspects of the present disclosure;

FIG. 4 illustrates a system architecture that supports a controllable irrigation system in accordance with various aspects of the present disclosure;

FIG. 5 illustrates a system architecture that supports an environment monitoring system in accordance with various aspects of the present disclosure; and

FIG. 6 illustrates an example of workflows that support a controllable irrigation system in accordance with various aspects of the present disclosure.

FIG. 7 schematically illustrates an example of a watering system having a self-charging wireless irrigation valve in accordance with various aspects of the present disclosure;

FIG. 8 schematically illustrates an example of a watering system having a self-charging wireless irrigation valve and a sprinkler head combination in accordance with various aspects of the present disclosure;

FIG. 9 schematically illustrates an example of a watering system having a self-charging wireless irrigation valve and a sprinkler head combination in accordance with the various aspects of the present disclosure; and

FIG. 10 schematically illustrates an example of a watering system having a plurality of sprinkler heads controlled by a self-charging wireless irrigation valve in accordance with various aspects of the present disclosure.

FIG. 11 is a flow diagram illustrating steps of an example method in accordance with various aspect of the present disclosure.

### DETAILED DESCRIPTION

Generally, irrigation systems may water sections of soil and/or landscaping by operating valves that control a zone, or a group of multiple spray heads, simultaneously. Typically, the radius and distance of spray heads may be manually set and are static during watering routines. Some systems may allow for automatic adjustment of watering times based on sensor or weather data. However, differences in shade, soil type, landscaping features, system design, and other factors often prevent optimal watering to all areas. To prevent underwatering, watering times may be based on and may compensate for the lowest efficiency areas. As a result, this may result in overwatering of other areas, which may lead to wasting of water and potential landscape damage.

In some examples, an irrigation system may use a valve on each of the spray heads which may allow each of the individual spray heads to be controlled independently. These individual spray heads may be automatically adjusted in various ways including the radius of the spray to provide appropriate watering to the desired area. Each of these individual spray heads may distribute water to each area as appropriate, even though each of the areas may have varying factors affecting the optimal watering schedule. In some examples, the irrigation system may receive feedback on watering demands for individual regions which may be by separate devices with sensors that gather data on relevant environmental factors.

Many of the shortcomings associated with existing irrigation systems as set forth above can be addressed with wireless control of the valves and/or sprinkler heads of the irrigation system. The need for wireless control may be addressed with battery-operated devices that are connected to the valve and/or sprinklers that include a wireless valve. These enable communication with the central controller and supply power to open and close the valve. Such battery operated devices, when using standard DC batteries, typically require periodic replacement of the batteries, thus increasing the burden of maintenance. A solution to address this limitation, particularly when hydroelectric generators are available, is to use rechargeable batteries that can be powered/recharged. Like other battery-operated devices, rechargeable batteries provide a wireless interface between the central controller and the valve, but are separate from either component. The present disclosure includes a device that combines a self-charging wireless valve controller and an irrigation valve in a single unit. This combined device can operate as a standalone device to control water flow to zones or it may be integrated into a sprinkler head or other irrigation device to control each irrigation device individually.

Aspects of the disclosure are initially described below in the context of a controllable irrigation system. Various examples of the controllable irrigation system are then described. These and other aspects of the disclosure are further illustrated by and described with reference to apparatus diagrams, system diagrams, and flowcharts that relate to the controllable irrigation system.

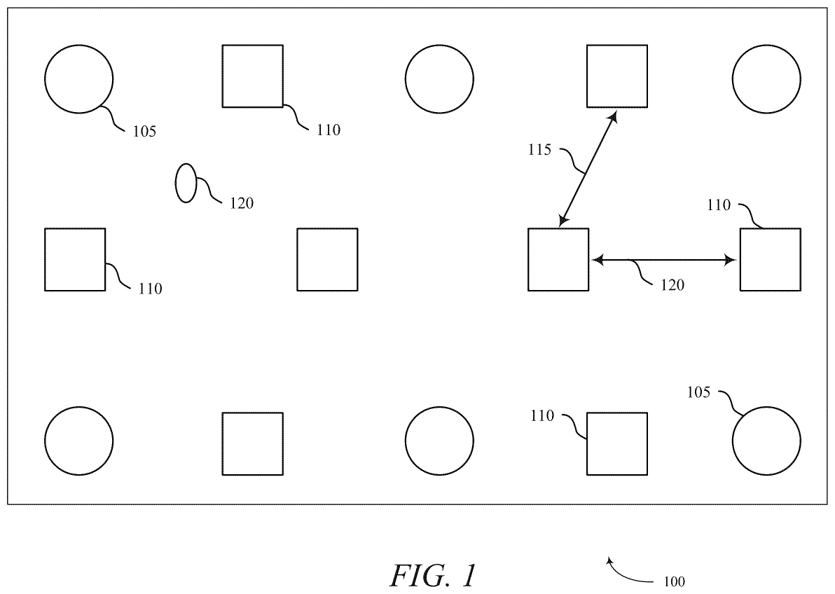

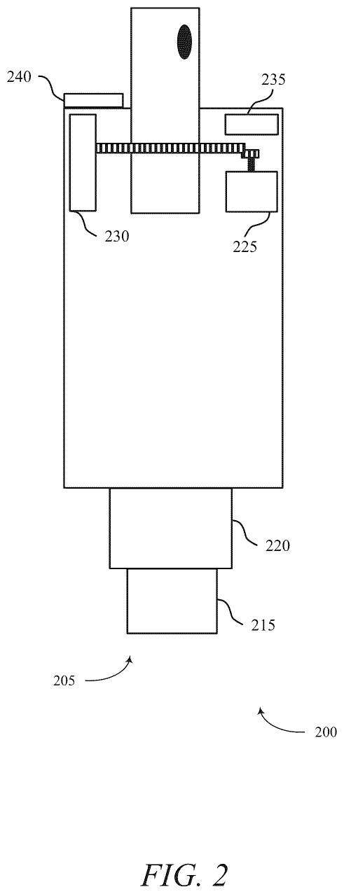

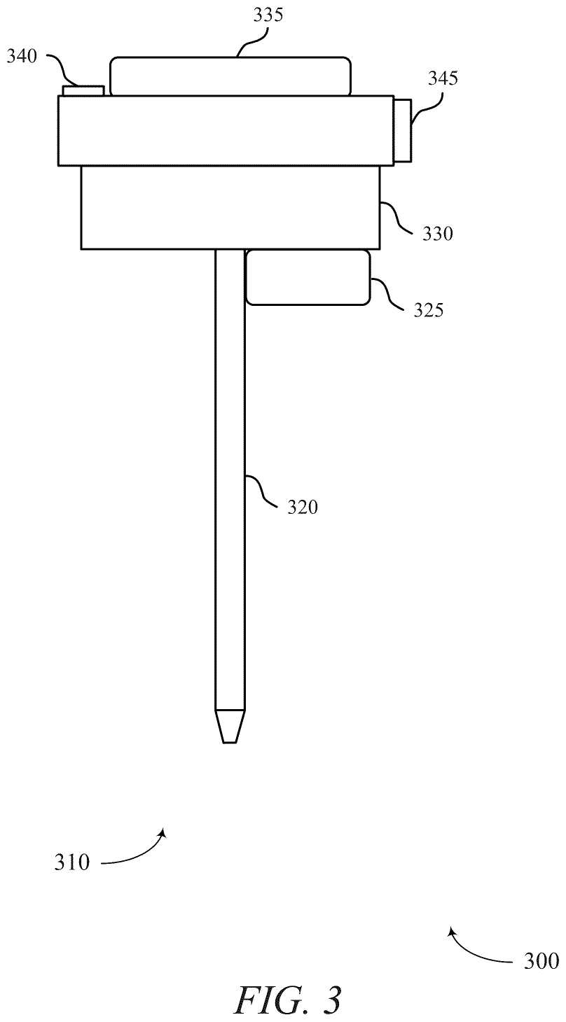

FIG. 1 illustrates an example of an irrigation system layout 100 that supports an automated irrigation system in accordance with various aspects of the present disclosure. The irrigation system layout 100 may include spray heads 105 and environment feedback sensors 110. In FIG. 1, the spray heads 105 may be placed in the irrigation area to provide appropriate watering distribution of the irrigation area. The spray heads 105 will be discussed in further detail herein and also with reference to at least FIGS. 2 and 3. Additionally, FIG. 1 is only one example of numerous possibility irrigation system layouts and is included for explanatory and discussion purposes. Irrigation areas may be any number of possible shapes and may be any size and the spay heads 105 and the environment feedback sensors 110 may be appropriately located in the irrigation area to provide the watering distribution demands of the irrigation area. In some examples, the controllable irrigation system may include three primary physical components, the spray head, the environment feedback sensor, and the hub, each of which will be discussed in further detail herein.

In some examples, existing spray heads of the irrigation system may be replaced with the controllable spray heads. Further, previously used flow valves may be replaced with a tube (e.g., a straight tube). Additionally, wires which may control the flow valves may be connected to the hub or system center or a separate device dedicated to this function (e.g., a wire terminal capable of providing a continuous low voltage). The hub may hold the valves in an open position or may open them as appropriate when operating the spray heads. In some examples, the previously installed sprinklers of the irrigation system may be retrofit with the controllable spray heads and the sprinkler wires from the previously installed valves can be inserted into the station terminals.

As illustrated in FIG. 1, the environment feedback sensors 110 may be located throughout the landscaping including the perimeter of the irrigation area and the interior of the irrigation area. The environment feedback sensors 110 may be approximately equally distributed to ensure that each of the regions may be adequately measured. In some examples, the distance 115 and the distance 120 between each of the environment feedback sensors 110 may be in the approximate range of 10-30 feet apart. In some examples, the distance 115 and the distance 120 between each of the environment feedback sensors 110 may be in the approximate range of 15-25 feet apart. In some examples, environment feedback sensors may be placed in regions that require differing amounts of coverage. For example, a separate sensor may be placed in a flower bed adjacent to a sensor in a lawn, which may require more or less watering. Additionally, the environment feedback sensors 110 may be located in areas and/or regions which generally have inadequate coverage. As used herein, the term environment feedback sensor may be any appropriate device that may be capable of making the appropriate moisture related measurements of the irrigation area.

In some examples, the irrigation system may include a temperature sensor such as a thermocouple or thermistor. The temperature sensor may allow sensing of the ambient temperature and may be used to refine the watering program algorithms.

In some examples, a user may set the widest spray radius desired for each spray head manually, via a mobile application, software, or any other appropriate interface. The user may also enter additional information to help estimate an initial watering program. This may include the type of landscaping near each spray head (e.g., grass, trees, shrubs) or slope (e.g., elevation gain, elevation loss). Even though the initial parameters may be determined by the user, watering programs may be determined from feedback provided by the system sensors.

The controllable irrigation system may undergo an initial calibration during which each spray head may be turned on individually for a brief time. The controllable irrigation system may identify each of the environment feedback sensors with which each of the spray heads may have contact. This information may be used to restrict the spray radius during the watering routine. For example, an environment feedback sensor may register the soil or landscaping in the corresponding area as being low-moisture, as such the system may know which spray head or spray heads to turn on and which portion of the spray radius of each spray head to activate.

Watering schedules may be set by custom software. The software may include algorithms (e.g., machine learning algorithms) that process data collected from environment feedback sensors, temperature sensors, local weather forecasts, and so forth, and any combination thereof. These algorithms may be transmitted to the hub from a central database. The hub may send signals to each of the individual spray heads, turning them on and off, adjusting spray radius as appropriate to provide adequate watering to each region, and/or adjusting the water flow through the flow valve.

In one example, a region of the landscaping may be covered by three spray heads and initially, all three spray heads may be activated. A portion of this region may have lower coverage, and the spray radius of one or more heads may be adjusted to continue watering the low coverage area after the rest of the region has been adequately watered. In some examples, watering programs may be adjusted and refined over time using data received by the hub.

In one example, batteries may supply power to the spray heads and environment feedback sensors and the batteries may be rechargeable and/or replaceable. In some examples, the batteries may be removed and charged in a custom charging dock and the battery may be sufficient to supply power for a typical season of watering.

In some examples, the irrigation system 100 may be automated and self-managed, and the watering schedules may be adjusted according to an algorithm. The algorithm may consider data collected by the irrigation system 100 and user-defined parameters such as local watering restrictions. In some examples, the irrigation system 100 may be controlled through a mobile and/or web application that provides manual adjustment and control of the irrigation system 100. The proximity of the environment feedback sensors 110 and spray heads 105 may be determined using wireless communication. The proximity may be determined relative to other spray heads 105 and environment feedback sensors 110 and/or the hub or other components of the sprinkler system 100. An example wireless communication system that provides such wireless communications capabilities is Bluetooth 5.1 technology. It may be possible to use a combination of Bluetooth and piezoelectric devices to determine proximity.

FIG. 2 illustrates an example 200 of a spray head 205 of a controllable irrigation system, such as system 100 of FIG. 1, that supports a controllable irrigation system in accordance with various aspects of the present disclosure. In some examples, the spray head 205 of FIG. 2 may implement aspects of the spray head 105 of FIG. 1. Additionally, similar components may have corresponding numbers in each of the figures. For example, spray head 105 of FIG. 1 may be the same or a similar element to spray head 205 of FIG. 2. The spray head 205 may distribute water to the landscaping and/or soil.

As illustrated in FIG. 2, the spray head 205 may include a solenoid 215. In some examples, the solenoid may be a DC latching solenoid 215. The DC latching solenoid 215 may be a valve which may control the flow of water to each of the spray heads 205 of the irrigation system. Although solenoids may be employed in some watering systems, the solenoid merely controls the water flow to water zones. In the irrigation system 100 of FIG. 1, each of the spray heads may have a DC latching solenoid 215 which allows the water flow of each of the individual spray heads to be controlled individually.

The spray head 205 of FIG. 2 may also include a battery 230 and a hydroelectric generator 220. The hydroelectric generator 220 may reduce the power demands of the watering system. The battery 230 may power the operation of the spray head and may be rechargeable and/or replaceable. The battery 230 may power the wireless communication adapters, the DC latching solenoid 215, and any other appropriate component of the spray head 205 that has a power demand. In some examples, the spray head 205 and/or the irrigation system may additionally include one or more solar panels 240. The solar panel(s) 240 may function to supply additional charge to the battery. The hydroelectric generator 220 may generate power to charge and/or recharge the battery 230 of the spray head 205. The hydroelectric generator 220 may include a turbine and water flow may engage the turbine which may provide current to the battery 230 and/or a motor 225 during operation of the spray head 205. The turbine may provide water flow volume data to estimate water usage. In some embodiments, the hydroelectric generator 220 may concurrently power aspects of the system and charge battery 230. In some examples, the battery 230 may be a rechargeable lithium polymer battery such as a 3.7V, 850 mAh battery. In some examples, the battery 230 may be a non-rechargeable battery such as a 1.5V, 2400 mAh (e.g., “AA” size) or 1000 mAh (e.g., “AAA” size). In some examples, a coin cell battery may be used such as a CR2032 or CR2025.

In some examples, the spray head 205 may include the motor 225 which may be any appropriate type of electromechanical motor (e.g., a stepper motor, a hydromechanical motor). The motor 225 may control the rotation of the spray head 205 and accordingly may control the spray radius of the spray head 205. The motor 225 may provide 360 degree control of the spray head 205 while allowing an on-demand adjustment of the spray radius of the spray head 205. The on-demand adjustments may be received via the wireless communication adapter 235. Each spray head 205 may include the wireless communication adapter 235 which may be a WiFi (e.g., ESP8266), LTE (e.g. LTE-M) and/or Bluetooth adapter (e.g., BLE 5.1). The wireless communication adapter 235 may allow communication between each of the components of the system including the hub. In some examples, the wireless communications adapter 235 may be a transceiver, which may be configured to transmit and receive signals (e.g., data, messages, adjustments to the spray radius and water flow).

FIG. 3 illustrates an example 300 of an environment feedback sensor 310. In some examples, the environment feedback sensor may support a controllable irrigation system, such as system 100 of FIG. 1, in accordance with various aspects of the present disclosure. In some examples, the environment feedback sensor 310 of FIG. 3 may implement aspects of the environment feedback sensor 110 of FIG. 1. The environment feedback sensor 310 may measure and/or sense the moisture in the landscaping and/or soil in the watering area and may provide feedback measurements to the irrigation system on soil moisture.

As illustrated in FIG. 3, the environment feedback sensor 310 may include a soil moisture sensor probe 320. The soil moisture sensor probe 320 may be a probe that may be inserted or pushed into the soil. The soil moisture sensor probe 320 may measure the water content of the soil using any appropriate method (e.g., capacitive humidity). The soil moisture sensor probe 320 may vary in length where the variations in length may be used to estimate the depth of moisture saturation of the irrigation system in the soil.

The environment feedback sensor 310 may include a piezoelectric sensor 335. The piezoelectric sensor 335 may generate a signal in response to physical impact. The piezoelectric sensor 335 may provide feedback when the water from the spray head contacts the environment feedback sensor 310. The signal generated by the piezoelectric sensor 335 may be used during an initial calibration procedure of the spray heads of the irrigation system. In some examples, the piezoelectric sensor may be 27 mm diameter, may have 4.2 kHz resonant frequency and may have 25000 pF of capacitance.

In some examples, the irrigation system may include a temperature sensor, such as a thermocouple. The temperature sensor (e.g., a thermocouple) may allow sensing of the ambient temperature and may be used to refine the watering program algorithms.

Similar to FIG. 2, FIG. 3 may include a battery 325. The battery 325 may power the operation of the environment feedback sensor 310 including the wireless communication adapters 330, and any other component of the environment feedback sensor 310 that has a power demand. In some examples, the environment feedback sensor 310 and/or the irrigation system may additionally include one or more solar panels 340. The solar panels 340 may function to supply additional charge to the battery 325. In some examples, the environment feedback sensor 310 may include one or more environment sensors 345 that sense environmental conditions such as, for example, temperature, humidity, wind speed, barometer, rain amount, and/or light, or other parameters such as, for example, relative position of objects and movement of objects. Additionally, each environment feedback sensor 310 may include the wireless communication adapter 330 which may be a WiFi (e.g., ESP8266), Bluetooth (e.g., BLE 5.1) and/or LTE (e.g., LTE-M) adapter. In some examples, the wireless communication adapter 330 may be a transceiver configured to transmit and receive signals (e.g., data, messages). The wireless communication adapter 330 may allow communication between each of the components of the system including the hub. In some examples, the battery 325 may be a rechargeable lithium polymer batter such as a 3.7V, 850 mAh battery. In some examples, the battery 325 may be a non-rechargeable battery such as a 1.5V, 2400 mAh (e.g., “AA” size) or 1000 mAh (e.g., “AAA” size). In some examples, a coin cell battery may be used such as a CR2032 or CR2025.

In some examples, the hub may transmit a message to the environment feedback sensor 310 requesting a reading from the environment feedback sensor. The environment feedback sensor 310 may receive the message from the hub and may check the soil moisture and measure the moisture values. The environment feedback sensor 310 may read that the soil moisture has dropped below a predetermined dryness threshold and may transmit a message (e.g., SOIL DRY MQTT) to the hub. The hub may receive the message from the environment feedback sensor 310 and may transmit a message to sprinklers or spray heads in the areas corresponding to the environment feedback sensor 310 to turn on. Additionally, or alternatively, the hub may operate to change the water flow and/or on/off state of the spray head. The hub may continue to poll the environment feedback sensors 310 at regular time intervals to verify whether or not the soil has been adequately watered. The hub may receive an “OK” message from the environment feedback sensor 310 and may turn off or reduce the water flow of the corresponding sprinklers or spray heads or the hub may receive a “SOIL DRY” message from the environment feedback sensor 310 and may continue watering or in some cases may increase the water flow of the spray head. Alternatively, the duration of watering may be determined by an algorithm optimized to ensure adequate soil moisture is retained for a desired length of time. In other words, it may be possible that the sensor would only serve as an “on” trigger and not as an “off” trigger.

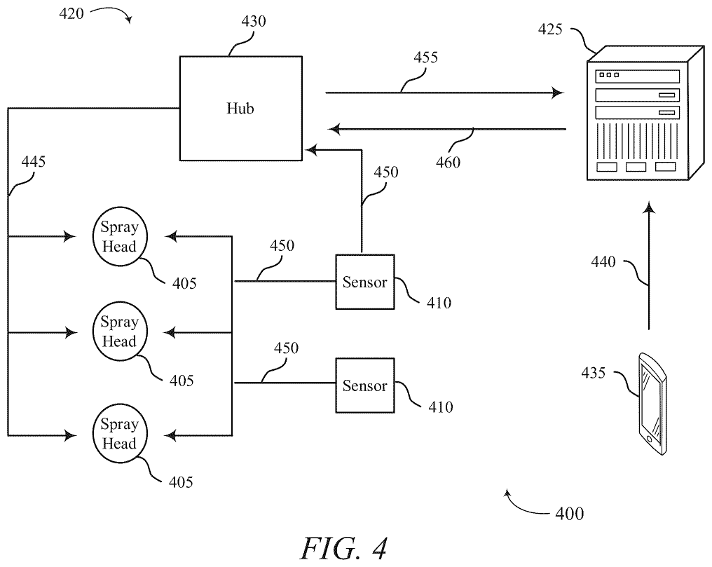

FIG. 4 illustrates an example 400 of a system architecture 420 for an irrigation system, such as system 100 of FIG. 1, that supports a controllable irrigation system in accordance with various aspects of the present disclosure. In some examples, the system architecture 420 may include environment feedback sensor 310 of FIG. 3 which may implement aspects of the environment feedback sensor 110 of FIG. 1. The environment feedback sensor 310 may measure and/or sense the moisture in the landscaping and/or soil in the watering area and may provide feedback measurements to the irrigation system on soil moisture.

In FIG. 4, the system architecture 420 may include a server 425 which may host a database for the irrigation system and also the endpoints for interacting with data provided by at least the environment feedback sensors. In some examples, the server 425 may include and/or utilize a Ruby on Rails API, MQTT broker for message transmission, and Redis/Sidekiq for background processing. The server 425 may be responsible for making changes to the database and notifying the hub 430 of any changes such as updates to algorithms determining the watering area or any adjustments to be made to the spray heads. The server 425 may also include the functionality of user and/or hub authentication logic and/or authorization. In some examples, the server 425 may transmit information to the hub 430 via MQTT protocol at 460 and the server 425 may receive information from the hub 430 via HTTP(S) protocol at 455. The hub 430 may make HTTP(S) update requests to the server 425 for consistency.

The hub 430 may control operation of the nodes, which may be referred to as spray heads and/or environment feedback sensors herein. In some examples, the hub may control operation of the spray heads based on data received from the environment feedback sensors. The hub 430 may also facilitate communication between a remote database which may be hosted by the server 425, receiving updates to watering schedule algorithms, and may receive update messages from the server 425 and make changes to relevant spray heads. In some examples, the hub 430 may be a CPU (e.g., Raspberry PI) and may include MQTT broker, and Redis/Sidekiq. The hub may wirelessly communicate via WiFi, LTE and/or Bluetooth adapters with the server 425, the environment feedback sensors 410, the spray heads 405, and any other wireless device such as user endpoint 435 (also referred to as a user access point or a mobile device 435). Additionally, the hub may have memory which may additionally host the some or all of the predetermined values, message, and/or data from the environment feedback sensors. Further, the hub memory may host the database instead of or in addition to the database hosted by the server 425.

The user access point (e.g., a mobile device or desktop application) 435 may communicate with the irrigation system, via the server 425. The user endpoint 435 may use a native application which may provide an interface for the irrigation system configuration. The user access point 435 via the native application may send configuration information and/or configuration values to the server 425 via HTTP(S) requests 440. In some examples, the user endpoint 435 via the native application may also provide an entry point for the initial hub configuration via Wi-Fi.

In some examples, a user may navigate to the sprinklers in a user access point application dashboard. The user may then set the sprinkler state to “on”. The user access point application may transmit an HTTP(S) PUT request to an application programming interface and the application programming interface may update the sprinkler record. The application programming interface may then transmit the MQTT message to the hub 430. The hub 430 may relate the MQTT “SET ON” message to the corresponding sprinkler or spray head 405 and the sprinkler or spray head 405 may turn on to water the landscaping or soil.

The spray heads 405 of the system architecture 420 may receive update messages from the hub 430 through MQTT at 445. The sprinkler components such as the spray head radius and water flow may be adjusted according to messages received from the hub 430. In some examples, the individual spray heads 405 may report issues with the spray head (e.g., the control valve) to the hub 430 via the MQTT message at 445. In some examples, the sensors 410 may evaluate and report relevant data. The sensors 410 may send messages to the hub 430 via MQTT at 450 when the environment feedback sensors 410 values exceed or drop below a given or predetermined threshold.

In some examples, the spray heads 405 and environment feedback sensors 410 may receive and transmit data wirelessly and may be battery operated. In some cases, power consumption may be reduced by employing DC latching solenoid valves as previously described. These DC latching solenoid valves may be used for the spray heads. Additionally, solar panels may also be incorporated into the spray heads 405 and/or environment feedback sensors 410 to assist in charging the battery.

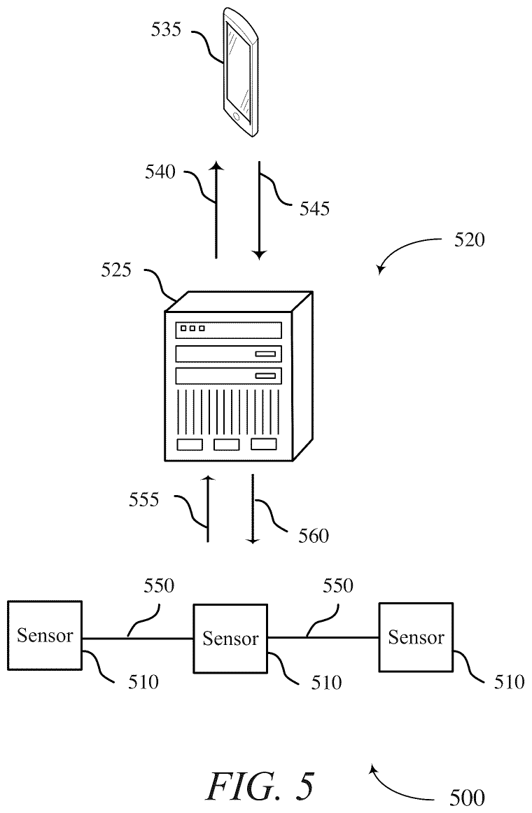

FIG. 5 illustrates an example 500 of a system architecture 520 for an environment monitoring system in accordance with various aspects of the present disclosure. In some examples, the system architecture 500 may include one or more sensors, such as one or more of the environment feedback sensors 310 of FIG. 3. The environment feedback sensor 310 may measure and/or sense, for example, the moisture in the landscaping and/or soil, temperature, humidity, or light intensity.

Similar to FIG. 4, FIG. 5 may include a server 525 utilizing similar methods for message transmission and background processing. In some examples, the server may transmit information at 555 and receive information at 560 directly to the environment feedback sensors 510. The server 525 may transmit data the user access point 535 at 540. The user may provide instructions to modify environment monitoring system behavior at 545 (e.g., the user may change the frequency at which the environment feedback sensors 510 acquire data). In some examples, the environment feedback sensors 510 may be interconnected at 550 via a wireless mesh network.

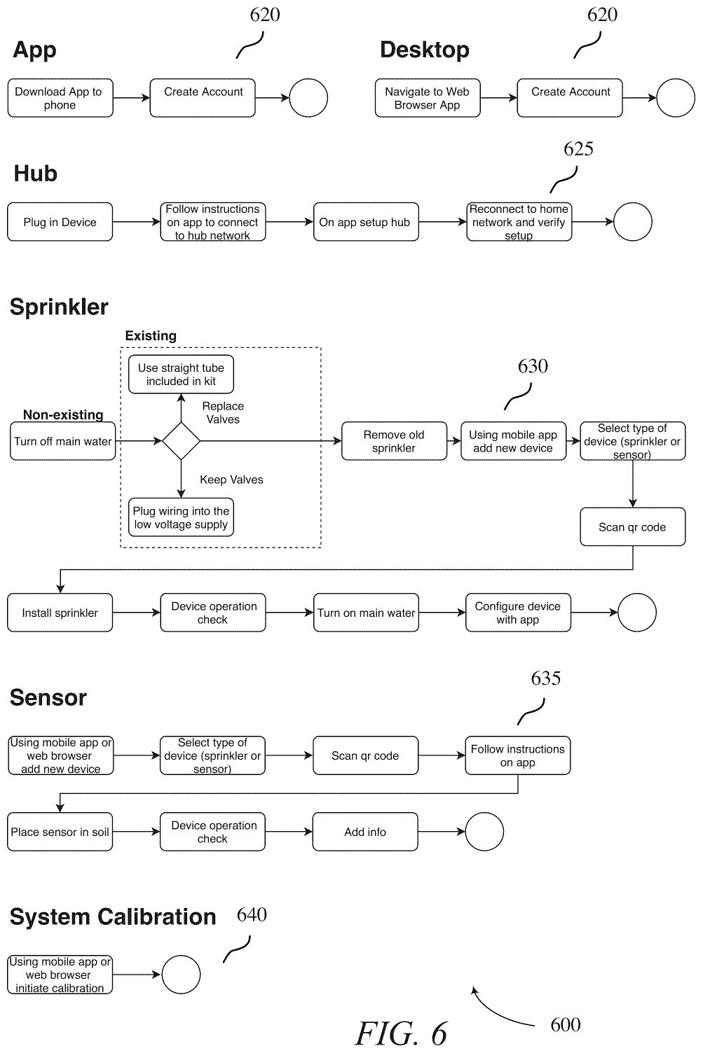

FIG. 6 illustrates a system setup workflow 600 that supports a controllable irrigation system in accordance with various aspects of the present disclosure. In some examples, the system setup workflow may include a workflow for a spray head and an environment feedback sensor which may implement aspects of the spray head 105 and the environment feedback sensor 110 of FIG. 1.

The workflow 620 may be for an application for use on a user access point. The application may be downloaded to the phone, mobile device, or desktop computer and an account may be created.

The workflow 625 may be for the irrigation system hub. The hub is plugged into a power source to power on the hub. The hub may transmit its own network to allow the user access point to connect to it. The mobile app will then facilitate the hub connecting to the user's personal WiFi network. The user may verify that the setup is correct.

Another workflow 630 may be for a sprinkler or spray head. The workflow 630 may begin by turning off the main water to the irrigation system. In one example, the valves may be replaced with a straight tube which may be included in the irrigation system kit or the existing valves may be used and wiring may be plugged into the low voltage power supply, and then the old existing sprinklers or spray heads may be removed. Next, using the application on the user access point, a new device or spray head may be added. The type of device (e.g., spray head or environment feedback sensor) may be selected and/or a QR code may be scanned. The controllable spray head or sprinkler may be installed and an operation check may be performed. At this point, the main water may be turned back on and the newly added device (e.g., spray head or environment feedback sensor) may be configured using the application on the user endpoint.

Another workflow 635 may be for a sensor of the irrigation system. The workflow 635 may begin by using an application on a user access point to add a new device. The type of device (e.g., sprinkler or environment feedback sensor) may be selected and/or a QR code may be scanned. The user may then follow the instruction on the application. Next, the sensor may be placed in the soil or landscaping and a device or environment feedback sensor operation check may be performed. Any remaining relevant information may be added using the application on the user endpoint and by the user.

In some examples, a system calibration 640 may be performed by using an application on a user access point to initiate the calibration of the system.

Thus, the workflows of FIG. 6 may provide methods used in conjunction with controllable irrigation systems. It should be noted that methods of FIG. 6 describe possible implementations, and that the operations and the steps of each of the workflows may be rearranged or otherwise modified such that other implementations are possible. In some examples, aspects from two or more of the workflows may be combined.

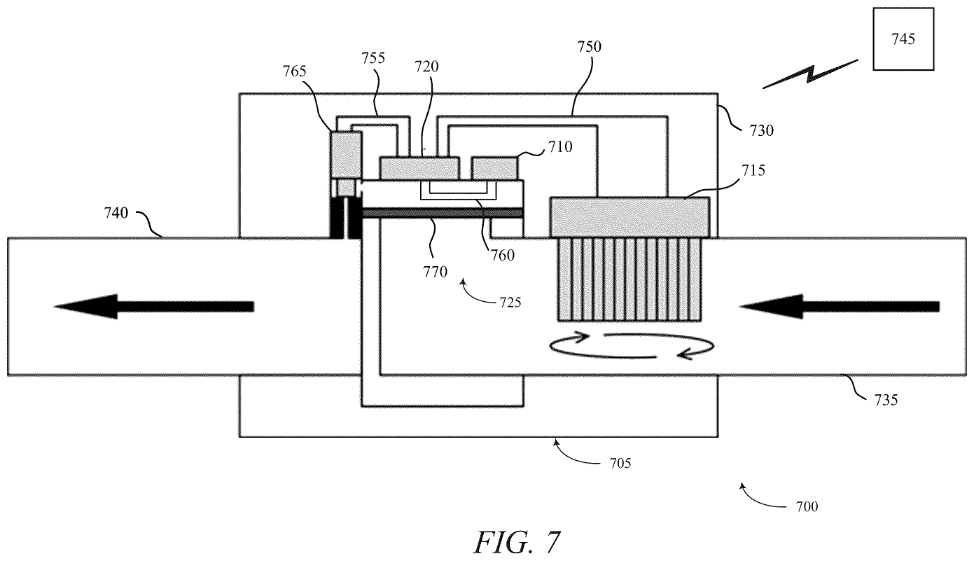

FIG. 7 schematically illustrates an example watering system 700 that includes a self-charging wireless irrigation valve 705 in wireless communication with a controller 745. The valve 705 includes a wireless communication device 710, hydroelectric generator 715, a rechargeable battery 720, a valve mechanism 725, a housing 730, and inlet and outlet lines 735, 740. The wireless communication device 710 facilitates wireless communication with the controller 745, which is positioned remote relative to the valve 705. The valve 705 communicates wirelessly with the controller 745 and is capable of operating without a wired connection to a power source outside of the valve 705 itself. Typically, as described above, these same wires used to connect a valve to a controller to provide a direct communication line for delivery of control signal also deliver power from the location of the controller to the valve for operation of the valve mechanism. The valve 705 includes hydroelectric generator 715, which is operable to provide power to rechargeable battery 720 to charge the battery. The rechargeable battery 720 operates as a power source for the valve mechanism 725. The valve mechanism 725 opens and closes to control waterflow from the inlet line 735 to the outlet line 740.

The wireless communication device 710 receives and relays the control signal received wirelessly from the controller 745. The control signal is to either open or close the valve mechanism 725. In some embodiments, the control signal may include instructions for a variable amount of opening or closing the valve. The wireless communication protocol may be Wi-Fi (e.g., ESP8266), Bluetooth (e.g., BLE 5.1), or LTE adaptor, similar to the wireless communication adaptor 235 described above. In some examples, the wireless communications adaptor 710 may be a transceiver, which may be configured to transmit and receive signals (e.g., data, messages, adjustments to the size of opening for the valve mechanism 725, etc.).

The hydroelectric generator 715 converts energy from the flow of water through the inlet line 735 to the outlet line 740 into electricity. The hydroelectric generator 715 includes a turbine that rotates as a result of the water flow in the inlet and/or outlet line 735, 740, depending on the location of the hydroelectric generator 715. The turning turbine rotates a rotor that carries a plurality of magnets. Wire coils are positioned in proximity to the rotor. The wire coils capture the electrical energy that is produced by the rotating magnets and transmits this energy to the rechargeable battery 720. For example, the hydroelectric generator may be 5V hydroelectric generator, although other voltage generators in the range of about 1V to about 20V (e.g., 12V) are contemplated and possible. The hydroelectric generator 715 can be situated either upstream or downstream of the valve mechanism 725.

The rechargeable battery 720 supplies power to the wireless communication device 710. The power supplied by rechargeable battery 720 may also be used to operate the valve mechanism 725, such as a solenoid actuator 765 that moves about mechanism 725 between opened and closed positions. The rechargeable battery 720 may be, for example, a rechargeable lithium polymer battery, although may other types of rechargeable batteries are possible. An example rechargeable lithium polymer battery is a 3.7V, 850 mAh battery. In some examples, one or more capacitors may be used in place of or in combination with a rechargeable battery.

In other examples, other types of power generation devices may be used in place of a hydroelectric generator or in combination with a hydroelectric generator. For example, the solar panels 340 described above with reference to FIGS. 2 and 3 may be used in combination with or in place of the hydroelectric generator 715.

The valve mechanism 725 operates to open and close to control flow of water through the valve 705. Various valve mechanisms may be used to accomplish this function. One such example is a diaphragm valve, which is common in the irrigation industry. Diaphragm valves include an inlet tube that is blocked by a pressurized, flexible diaphragm 770, as shown in FIG. 7. Waterflow is controlled by a solenoid 765 that changes the pressure on the diaphragm. Upon receiving a signal from the controller 745 via the wireless communication device 710, a signal is transmitted to the solenoid 765 to open or close the valve 705. The solenoid 765 is powered by, for example, the rechargeable battery 720.

Other types of valves and control mechanisms, actuators, and the like may be used with the valve 705 to control flow from the inlet line 735 to the outlet line 740. Typically, valve mechanisms that require relatively low amounts of power to operate are preferred, although power requirements should not be a limiting factor for the type of valve mechanism used with the valve 705.

The housing 730 for the valve 705 typically is sized and configured to hold the components of at least the wireless communication device 710, the hydroelectric generator 715, the rechargeable battery 720, and all or portions of valve mechanism 725. The housing 730 may comprise materials and/or have a construction that permits wireless communication between the wireless communication device 710 positioned therein and a remote-located controller 745. In some embodiments, the wireless communication device 710 may be positioned external the housing 730 in order to facilitate improved wireless communication. In some embodiments, the housing 730 only houses electronic components of the valve 705 such as the wireless communication device 710 and the rechargeable battery 720. The hydroelectric generator 715 and valve mechanism 725 may be positioned outside of the housing 730. Typically, connecting wires 750, 755, 760 provide electrical connection between the electronic components of the valve 705 (e.g., at least the hydroelectric generator 715, the rechargeable battery 720, and solenoid 765). In other arrangements, the electronic components of the valve 705 are mounted directly to a printed circuit board that provides needed electrical connection between components.

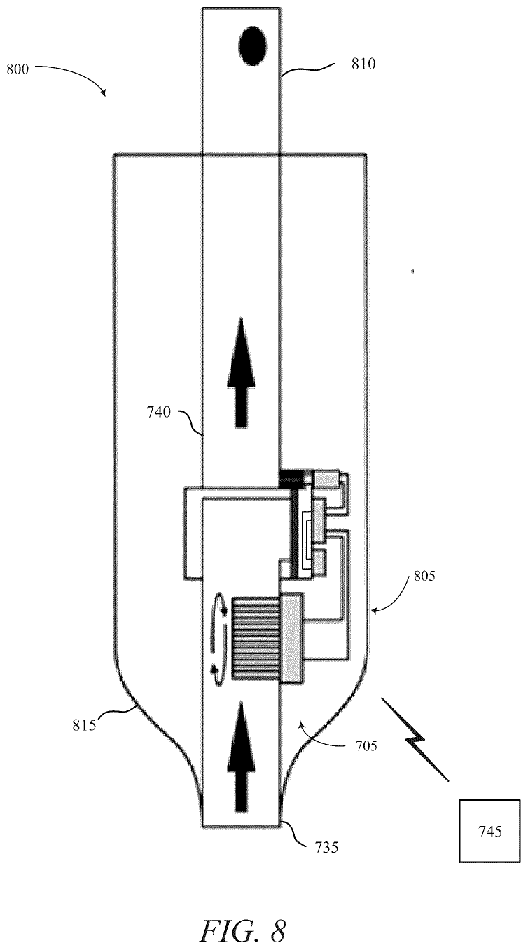

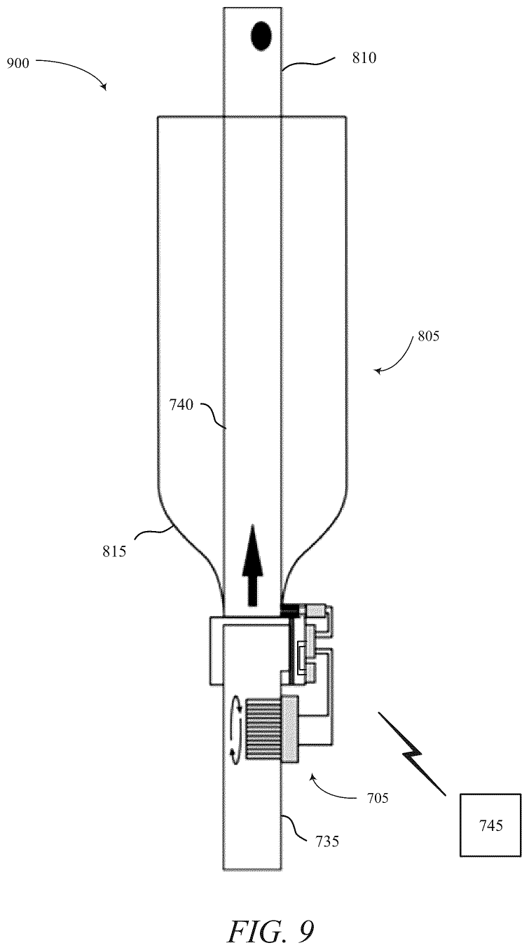

FIGS. 8 and 9 illustrate other example watering systems 800, 900, wherein the self-charging wireless irrigation valve 705 is integrated into or assembled with a sprinkler head 805. The sprinkler head 805 includes a dispenser 810 and a housing 815. FIG. 8 illustrates the valve 705 positioned internal the housing 815 of the sprinkler head 805. FIG. 9 illustrates the valve 705 positioned external the housing 815. In both of the examples shown in FIGS. 8 and 9, the valve 705 may be considered mounted to, connected to, and/or assembled with the sprinkler head 805 to provide a watering device and/or watering system having a self-charging wireless irrigation valve. As described above with reference to FIG. 7, the valve 705 may communicate wirelessly with the controller 745.

The inlet and outlet lines 735, 740 for the valve 705, may be integrated into the sprinkler head 805 shown in FIGS. 8 and 9. For example, the outlet line 740 may be integrally formed with the dispenser 810. Further, portions of the housing 815 may act as a housing or covering for portions of the valve 705 in place of the housing 730 shown in FIG. 7. Alternatively, the valve 705, including housing 730, may having a unitary structure that, as a whole, is mounted to the sprinkler 805 such that the valve 705 can be interchanged, replaced, and/or accessed for maintenance, etc., independent of other features of the sprinkler head 805.

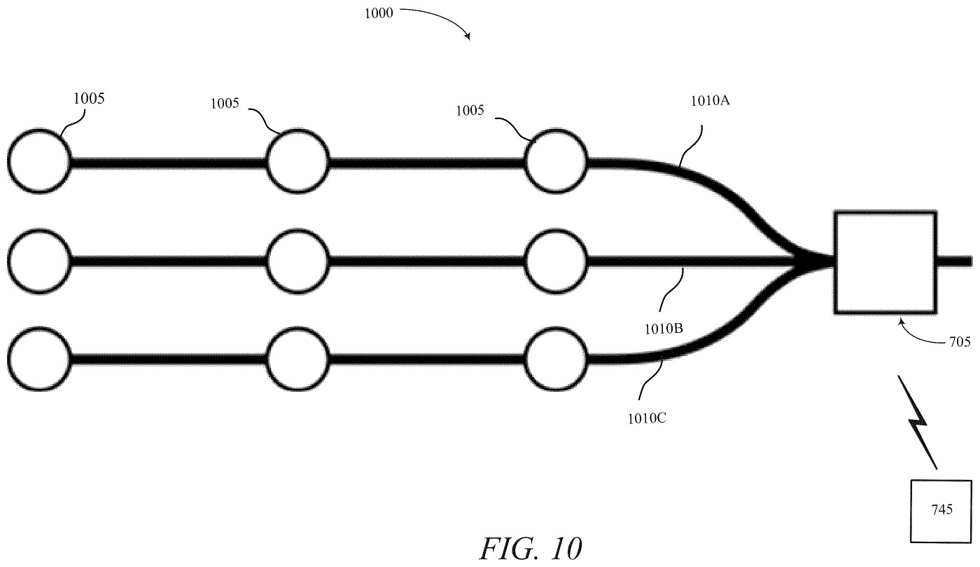

FIG. 10 illustrates another example watering system 1000 that includes valve 705 coupled in flow communication with a plurality of sprinkler lines 1010A-1010C, each having a one or more sprinkler heads 1005. The watering system 1000 shown in FIG. 10 may be described as a self-charging wireless irrigation valve 705 attached to a cluster of irrigation devices. In some arrangements, the valve 705 may be connected to a plurality of sprinkler heads or other irrigation devices that might otherwise be considered too small or too few in number for a typical irrigation zone. An example of the sprinkler heads 1005 might be cluster and/or drip irrigation emitters.

The ability of valve 705 to communicate wirelessly with a remote positioned controller 745 may permit use of more valves throughout a given irrigation system than may otherwise be possible because of the ability to provide a wired connection to each valve. The ability of valve 705 to not be constrained with limitations associated with providing a wired connection may provide increased flexibility regarding how different sprinkler heads, irrigation emitters, clusters of irrigation devices, and other water-related devices on a given property to be controlled in a more customized, unique way. Although the valve 705 has been described with reference to use with sprinklers in other related water dispensers, it may have equal applicability to other water dispensing devices such as hoses, birdbaths, water displays, water fountains, water draining devices, and the like, as well as other liquid dispensers within and outside of the irrigation field.

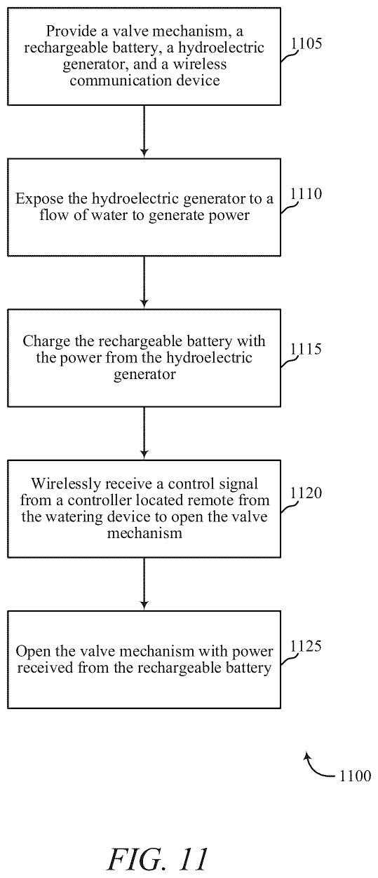

FIG. 11 illustrates a flow diagram of an example method 1100 in accordance with the present disclosure. The method 1100 includes, at block 1105, providing a valve mechanism, a rechargeable battery, a hydroelectric generator, and a wireless communication device. Block 1110 includes exposing the hydroelectric generator to a flow of water to generate power. Block 1115 includes charging the rechargeable battery with the power from the hydroelectric generator. Block 1120 includes wirelessly receiving a control signal from a controller located remote from the watering device to open the valve mechanism. Block 1125 includes opening the valve mechanism with power received from the rechargeable battery.

The method 1100 may also include providing a sprinkler, and opening the valve mechanism delivers a flow of water to the sprinkler. The method 1100 may include providing a plurality of sprinklers, and opening the valve mechanism delivers a flow of water to the plurality of sprinklers. The watering device may be mounted to a housing of a sprinkler, and opening the valve mechanism may deliver a flow of water to the sprinkler. The control signal may be received wirelessly via one of WiFi, Bluetooth, and LTE.

The description herein provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. Also, features described with respect to some examples may be combined in other examples.

The description set forth herein, in connection with the appended drawings, describes example configurations and does not represent all the examples that may be implemented or that are within the scope of the claims. The term “exemplary” as may be used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a digital signal processor (DSP) and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (e.g., A and B and C).

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable read only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not to be limited to the examples and designs described herein but is to be accorded the broadest scope consistent with the principles and novel features disclosed herein.

What is claimed is:

1. A watering device, comprising:
a spray head configured to distribute water over a spray radius;
a control valve operably coupled to the spray head and configured to control water flow to the spray head independently from other spray heads;
a motor operably coupled to the spray head and configured to control approximately 360 degrees of rotation of the spray head independently from other spray heads; and
a wireless communication adapter operably coupled to the control valve and configured to receive soil moisture feedback, and further configured to adjust at least one of water flow to the spray head and rotation of the spray head based at least in part on the received soil moisture feedback.

2. The watering device of claim 1, further comprising:
a battery operably coupled to the spray head and configured to provide power to the spray head.

3. The watering device of claim 2, further comprising:
a solar panel operably coupled to the battery and configured to supply charge to the battery.

4. The watering device of claim 2, further comprising:
a hydroelectric generator configured to generate power for at least one of operating the spray head and charging the battery, wherein the battery may be operably coupled to the wireless communication adapter.

5. The watering device of claim 1, further comprising:
a piezoelectric sensor configured to generate a signal in response to a physical trigger, wherein the physical trigger may be water distributed from the spray head.

6. The watering device of claim 1, further comprising:
a temperature sensor communicatively coupled to the wireless communication adapter and configured to sense temperature.

7. The watering device of claim 1, wherein the control valve is a DC latching solenoid.

8. The watering device of claim 1, wherein the motor may be one of a DC motor or hydromechanical motor.

9. The watering device of claim 1, wherein the wireless communication adapter determines a proximity of the spray head with wireless communication.

10. A watering system, comprising:
a plurality of spray heads configured to distribute water to soil over a spray radius;
a plurality of environment feedback sensors configured to sense a water content of the soil included in the spray radius;
a controller configured to receive the water content of the soil from at least one environment feedback sensor of the plurality of environment feedback sensors and further configured to communicate with at least a spray head of the plurality of spray heads to adjust the water distribution of the spray head, wherein the adjustment of the water distribution of the spray head is independent of the adjustments of the water distribution of other spray heads of the plurality of spray heads.

11. The watering system of claim 10, wherein the water distribution adjustments may be at least one of spray radius, water flow, or watering time duration.

12. The watering system of claim 10, wherein the controller is configured to receive information from a database, wherein the database is configured to collect feedback from the plurality of environment feedback sensors.

13. The watering system of claim 10, wherein the controller is configured to receive update messages from a server instructing the controller to adjust at least one of the water flow or spray radius of at least one spray head of the plurality of spray heads.

14. An irrigation system, comprising:
a plurality of spray heads configured to distribute water to soil over a spray radius;
a plurality of environment feedback sensors configured to sense a water content of the soil;
a controller configured to:
request a water content value of soil from at least an environment feedback sensor of the plurality of environment feedback sensors;
receive the water content value from the environment feedback sensor of the plurality of environment feedback sensors;
identify that the water content value is below a threshold; and
adjust at least one of a water flow or the spray radius of a spray head of the plurality of spray heads, wherein the adjustment of the spray head of the plurality of spray heads is independent of other spray heads of the plurality of spray heads.

15. The irrigation system of claim 14, wherein the controller is configured to receive messages to periodically poll at least an environment feedback sensor of the plurality of environment feedback sensors.

16. The irrigation system of claim 14, wherein the controller is configured to determine proximity of the plurality of spray heads and plurality of environment feedback sensors using wireless communication.
